(19) United States
(12) Patent Application Publication
(10) Pub. No.: US 2004/0148311 A1
(43) Pub. Date: Jul. 29, 2004

(54) Displaying a multipage file for convenient visual checking

(75) Inventor: Kazushige Sawada, Yokohama-shi (JP)

Correspondence Address: David R. Irvin, IBM Corporation, T81/503, PO Box 12195, Research Triangle Park, NC, 27709, US

(73) Assignee: International Business Machines Corporation, Armonk, NY

(21) Appl. No.: 10/758,575

(22) Filed: Jan. 15, 2004

(30) Foreign Application Priority Data
Jan. 23, 2003 (JP) 2003-015339

(51) Int. Cl. G06F 7/00

(52) U.S. Cl. 707/102

(57) ABSTRACT

To make it easier to visually check entries in documents such as multipage business forms, form data is gathered in a file containing a plurality of forms. The form data is read, and then a form on the first page is displayed in a window. Under control of an operator, an item such as an entry on the form to be checked on the first page is displayed with scrolling, and its display area is fixed and stored. When the operator initiates the display of a form on the second page, the window displays the same area as the display area of the form on the first page. It is also possible to display an item to be checked in a central portion of the window or to search a plurality of pages for an item to be checked.

### FIELD OF THE INVENTION

The present invention relates generally to a file display device for displaying the content of a file having a plurality of pages in a window, and more specifically to a file display device for a screen suitable for checking information such as a character or an image displayed in a window.

### BACKGROUND

Paper forms that include ruled lines, items, and so on to be filled-in with specific information have been widely used. Examples of these include purchase slips, sales slips, and shipping slips. Such forms are often checked visually. More recently, in order to enable computer processing, such forms have been represented electronically, i.e., text files or images of forms are used instead of paper copies. Electronic forms may be displayed to an operator who pages through them and checks them visually. One such approach is described in Japanese Published Unexamined Patent Application No. 10-269053.

When the next form page is displayed in a window of a display responsive to an operator's command, each form page is displayed with the upper left corner of the page brought back to a reference point. For example, the upper left corner of a page may be aligned with the upper left corner of the window. Alternatively, the next form page may be displayed by shifting by the width of a page, so as to align the page with respect to the left side of the window. Unfortunately, when the lower right part of a form page has an entry to be checked, the operator first needs to display the next form page in the window, scroll the window to the targeted position that displays the entry to be checked, and then visually check the entry. These operations decrease the productivity of the operator.

A common approach to solving the above-mentioned problem is to reduce the size of the form page displayed, i.e., to collapse the form. This makes it difficult to check pages visually, however, because the characters and images displayed are proportionally reduced in size. Another approach is to use a large display that can display an entire page, full size. This approach, however, is not really practical, because a remarkably large display may well be needed for a form with a correspondingly large page such as a form in JISA3 format.

The above-mentioned Japanese Patent Document No. 10-269053 shows a technology for displaying a file that includes a plurality of pages on a display by displaying a page enlarged in a main part of the display, while the page concerned is collapsed and arranged side-by-side with pages before and after in a sub-part alongside the main part. Further according to the Patent Document, when an operator specifies a given area in a page collapsed in a sub-part, the specified area is transferred into a main part and displayed in real time.

However, even if the technology described in the aforementioned Patent Document is used, when an operator switches from one displayed page to the next, the operator also has to specify an area to be displayed in the main screen. Therefore, this technique too suffers from undue complexity and low operator productivity.

### SUMMARY

The present invention facilitates an operator's visual check without complicating the operation by enabling the same area to be displayed in sequential pages, with an area displayed in one page reflected in a display of the next page, when the next page is displayed in turn.

A file display device according to the present invention includes display means for displaying the content of a file having a plurality of pages in a window, storage means for storing a display area of a given page in the file displayed in the window, and determination means for determining a display area of a page to be displayed next in the window on the basis of the display area of the given page stored in the storage means. In such a file display device, a determination means determines a display area of a page to be displayed next so that the same display area as that of the given page is displayed. The file display device further includes directing means for outputting a direction to the storage means, wherein the storage means stores a display area of a given page displayed in the window when the storage means receives a direction from the directing means.

The file display device further includes area selection means for selecting a certain area within the given page displayed in the window. The area selected by the area selection means is also displayed in a page other than the given page. The file display device further includes shifting means for shifting the area selected by the area selection means into substantially the central region of the window. The file display device further includes searching means for searching text information within the area selected by the area selection means over a plurality of pages in the file.

A form display device according to the present invention includes a storage unit for storing a form file wherein a single form page generated conforming to a given regular form corresponds to a single page and a plurality of form pages composes a single file, a display unit for displaying the form file stored in the storage unit in units of a page, and a display determination unit for determining a display area of the form file on the display unit so that the display area is fixed to the same position within the form when the page is switched to another page. The form display device further includes a direction unit for directing the display determination unit to place an area within a form in the central region of the display area. The form display device further includes a selection unit for specifying a given area within a form as a selection area and a searching unit for searching text information within the selection area specified by the selection unit over a plurality of form pages in a form file.

The present invention includes a program for causing a computer to execute a function of displaying a file having a plurality of pages in a window on a display, the program further causing the computer to execute the functions of displaying a given page of the file in the window, storing a display area of the given page displayed in the window, and displaying another page of the file in the window so that the same display area as that of the given page is displayed on the basis of the display area of the stored given page. The program further causes the computer to execute the functions of selecting a certain area within the given page displayed in the window, and displaying the selected area in the window with the area shifted into nearly the central region of a display area of the window. The program further causes the computer to execute the functions of selecting a certain area within the given page displayed in the window, receiving a keyword associated with the selected area, comparing the keyword with text information contained in the certain area corresponding to each page of the file, one after another, and displaying a page of the file containing the text information in the window if the keyword and the text information match.

The present invention also includes a program for causing a computer to execute the functions of displaying a first page in a window on a display, storing a display area of the first page displayed in the window, and displaying a second page in a window so that the same display area as that of the first page is displayed on the basis of the display area of the stored first page. The present invention also encompasses the case wherein a first page and a second page are stored in different files.

The programs to be executed by a computer can be tangibly embodied in a storage medium that is readably stored by the computer. The storage medium may be a CD-ROM medium, for example, and may be in a form so that a program is read by a CD-ROM reader in a computer and, for example, stored on various types of memory in a computer such as a hard disk and executed. The program can also be in a form to be provided to a notebook PC or a portable terminal via a network with a program transmission unit, for example. It is enough for the program transmission unit to include memory for storing a program and program transmission means for providing a program over a network.

The present invention includes a method wherein respective functions in the above-mentioned programs are represented by steps.

### BRIEF DESCRIPTION OF THE DRAWINGS

FIG. 1 is a schematic diagram of an exemplary hardware configuration of a computer that is suitable for implementing a form display system according to the invention.

FIG. 2 is a block diagram illustrating functions of a form display system according to the invention.

FIG. 3 is a flowchart showing how a form may be displayed.

FIG. 4 continues the flowchart of FIG. 3.

FIG. 5 is a flowchart illustrating a form shifting function.

FIG. 6 is a flowchart illustrating an automatic scrolling function.

FIG. 7 is a flowchart illustrating a searching function.

FIGS. 8A and 8B show examples of form data.

FIG. 9 shows a window and FIX button displayed on a display device.

FIG. 10 shows a first page of a form displayed in a window.

FIG. 11 shows a form page to be displayed in a window shifted according to an operation by an operator.

FIG. 12 shows a state after the FIX button is clicked on.

FIG. 13 shows a second form page, which is displayed in a window when a form shifting function is executed.

FIGS. 14A and 14B show a process of displaying a selection area in the center of a window when an automatic scrolling function is executed.

FIG. 15 shows a state wherein a selection area of a form page is displayed in the center of a window.

FIGS. 16A, 16B, and 16C show a process of searching a character string within a selection area when a searching function is executed.

### DETAILED DESCRIPTION

Now, exemplary embodiments of the invention will be described with reference to the drawings.

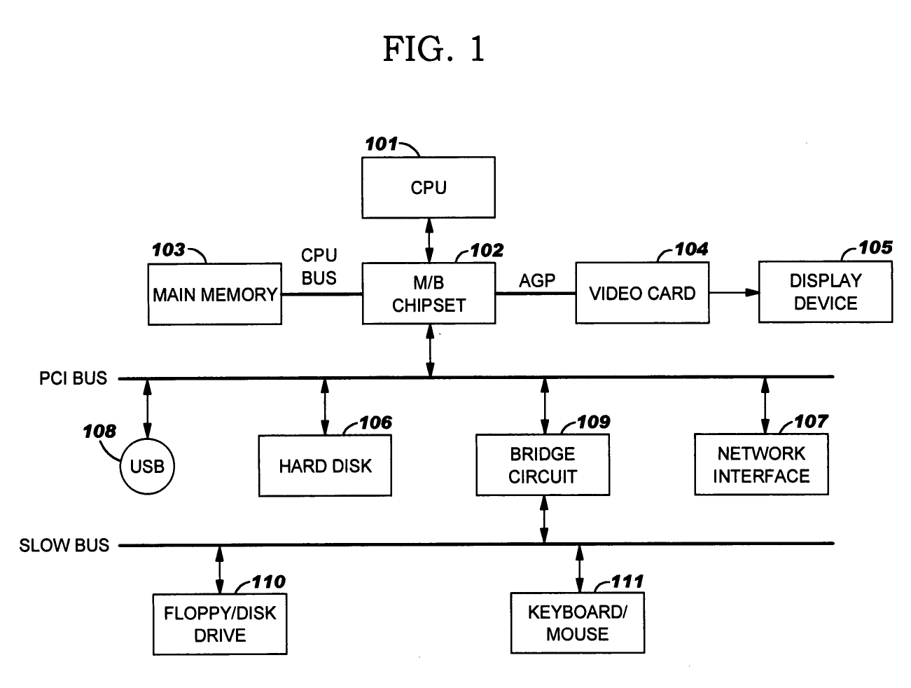

As shown in FIG. 1, a computer suitable for implementing the invention includes CPU (Central Processing Unit) 101 as operation means, main memory 103 as storage means connected to CPU 101 via M/B (motherboard) chip set 102 and CPU bus, video card 104 also connected to CPU 101 via M/B chip set 102 and AGP (Accelerated Graphics Port), display device 105 as display means for displaying graphic data generated at video card 104, hard disk 106, network interface 107, and USB108 connected to M/B chip set 102 via PCI (Peripheral Component Interconnect) bus, and floppy disk drive 110 and keyboard/mouse 111 as directing means and/or area selection means connected to M/B chip set 102 via bridge circuit 109 and slow bus such as ISA (Industry Standard Architecture) bus from PCI bus. As display device 105, a liquid crystal display (LCD) or a CRT display, for example, can be used.

FIG. 1 is exemplary rather than limiting; various other configurations can be employed as well. For example, the computer may have video memory instead of video card 104 so as to process image data in CPU 101, or may have a drive for a CD-ROM (Compact Disc Read Only Memory) or a DVD-ROM (Digital Versatile Disc Read Only Memory) via an interface such as ATA (At Attachment).

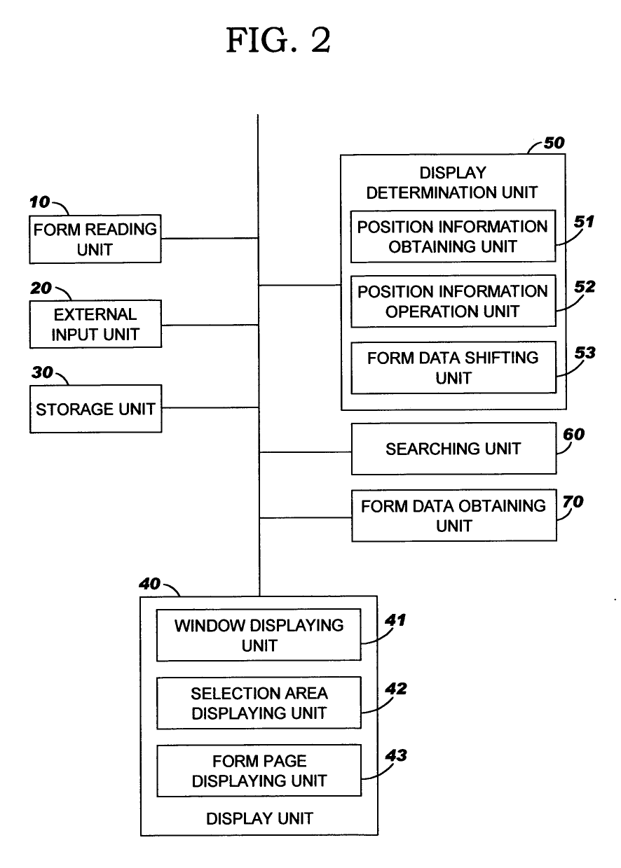

FIG. 2 is a block diagram illustrating functions of a form display system according to the invention. The exemplary embodiment includes form reading unit 10 for loading form data to be processed from outside into storage unit 30, external input unit (direction unit, selection unit) 20 for receiving commands from an operator, storage unit 30 for storing the above-mentioned form data and data such as position information of a form (to be described later) that is needed in the processing of each unit, displaying unit 40 for displaying a form page, display determination unit 50 for determining where to display a form page on display unit 40, searching unit 60 as searching means for searching form data in response to an operation from an operator received at external input unit. 20, and form data obtaining unit 70 for accessing data on a page to be processed from form data stored in storage unit 30 in response to an operation from an operator received at external input unit 20.

Display unit 40 includes window displaying unit 41 for displaying a window on a display, selection area displaying unit 42 for displaying a selection area (to be described later) selected by a command from an operator in a window, form page displaying unit 43 for obtaining form data after shifted through form data obtaining unit 70 and displaying the data in a window.

Display determination unit 50 includes position information obtaining unit 51 for obtaining position information for a form displayed in a window on display unit 40, position information operation unit 52 for operating the position of a form page to be displayed next in a window on the basis of position information obtained by position information obtaining unit 51, and form data shifting unit 53 for shifting a form page to be displayed next in a window by a predetermined distance in a predetermined direction on the basis of the operation result obtained by position information operation unit 52.

In the system configuration shown in FIG. 2, external input unit 20 is implemented by keyboard/mouse 111, and storage unit 30 is implemented by hard disk 106. Form reading unit 10, displaying unit 40, display determination unit 50, searching unit 60, and form data obtaining unit 70 are a software block implemented in CPU 101. A program for controlling CPU 101 to execute these functions may be provided on a magnetic disk, optical disk, semiconductor memory, or other recording medium, or delivered over a network, and read into main memory 103. The data or program held in main memory 103 can be saved in a recording device such as hard disk 106, if needed. Form reading unit 10 may be network interface 107 or USB 108 for enabling data to be read from an external recording medium (not shown) to storage unit 30.

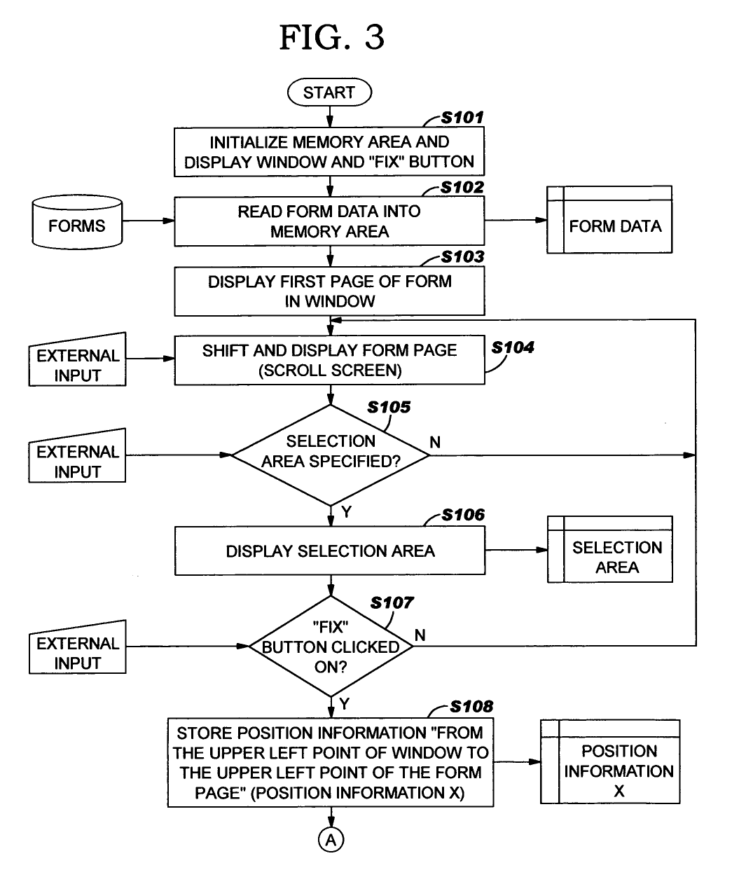

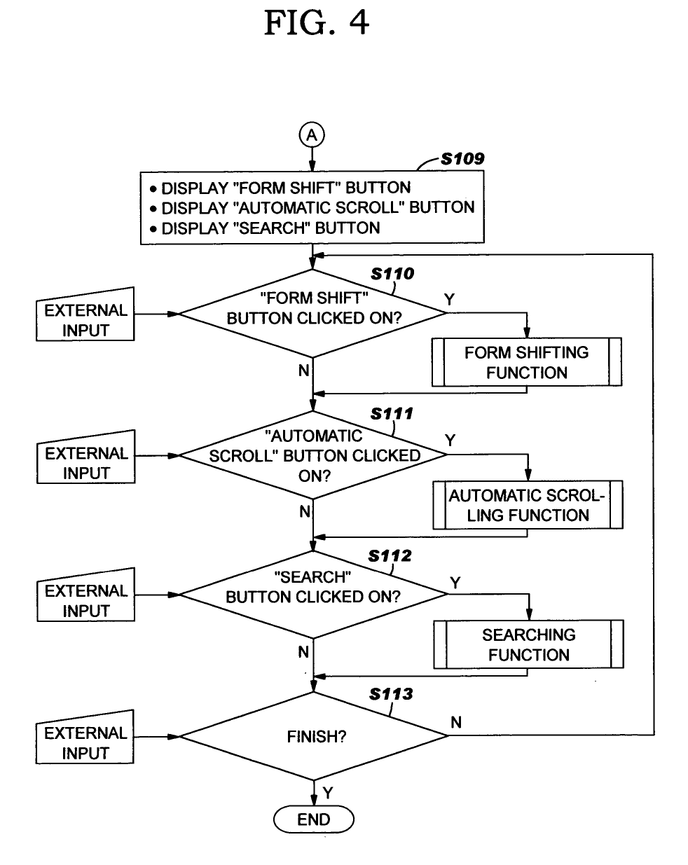

FIGS. 3 and 4 are flowcharts showing exemplary flows for displaying forms according to the invention. The term “form data” used below refers to data in a file that includes a plurality of form pages, where one sheet of a form corresponds to one page. In this embodiment, form data is generated in PDF (Portable Document File: trademark of Adobe) form.

Now, a specific flow of a process will be described.

First, a memory area is initialized, and a window with “FIX” button is displayed on window display unit 41 of display unit 40 (step 101). Operation of the FIX button will be described below. Then, a first page of form data obtained via form data obtaining unit 70 is read in the initialized memory area (storage unit 30) (step 102), and the first form page is displayed in a window by window display unit 41 (step 103).

Then, according to an operation from an operator, the form page is shifted and displayed (step 104). Specifically, an operator scrolls a screen by using external input unit 20 so that an entry of a form that the operator wants to check is displayed. Next, determination is made whether the operator specified a selection area (certain area) or not (step 105). A selection area is an area which an operator specifies by mouse-dragging a certain area within a form displayed in a window. If it is determined that the operator specifies a selection area at step 105, selection area displaying unit 42 on display unit 40 displays the selected selection area (step 106). A selection area may be displayed with, for example, the selection area surrounded by a frame or with the selection area in a reverse image. The selected selection area is stored in storage unit 30. If it is determined that the operator does not specify a selection area at step 105, the process returns to step 104 where processing continues.

After the selection area is displayed at step 106, a determination is made as to whether the operator clicks on the FIX button or not (step 107). If the operator clicks on the FIX button, position information obtaining unit 51 of display determination unit 50 obtains position information on a window, and a form page currently displayed in the window, from the upper left point of the window to the upper left point of the form page. The position information is stored in storage unit 30 as position information X (step 108). Position information X is vector information which includes components of distance and direction. If the operator does not click on the FIX button at step 107, the process returns to step 104 where processing continues.

After position information X is stored at step 108, window displaying unit 41 on display unit 40 hides the FIX button in the window and further displays a “FORM SHIFT” button, “AUTOMATIC SCROLL” button, and “SEARCH” button in the window (step 109). Functions of the FORM SHIFT button, AUTOMATIC SCROLL button, and SEARCH button will be described later.

Then, a determination is made as to whether the operator clicks on the FORM SHIFT button or not (step 110). If the operator clicks on the FORM SHIFT button, form shifting function SA, which is a subroutine for displaying the next form page, is executed, and the process proceeds to the next step 111. If the operator does not click on the FORM SHIFT button, the process directly proceeds to the next step 111. Form shifting function SA will be described in detail later.

Then, a determination is made as to whether the operator clicks on the AUTOMATIC SCROLL button or not (step 111). If the operator clicks on the AUTOMATIC SCROLL button, automatic scrolling function SB, which is a subroutine for displaying the next form page in the automatic scrolling display, is executed, and the process proceeds to the next step 112. If the operator does not click on the AUTOMATIC SCROLL button, the process directly proceeds to the next step 112. The automatic scrolling function SB will be described in detail later.

Then, a determination is made as to whether the operator clicks on the SEARCH button or not (step 112). If the operator clicks on the SEARCH button, searching function SC, which is a subroutine for searching, is executed, and the process proceeds to the next step 113. If the operator does not click on the SEARCH button, the process directly proceeds to the next step 113. The searching function SC will be described in detail later.

Then, a determination is made as to whether the operator commands the process to finish (step 113). If so, the process ends. If not, the process returns to step 110 where processing continues.

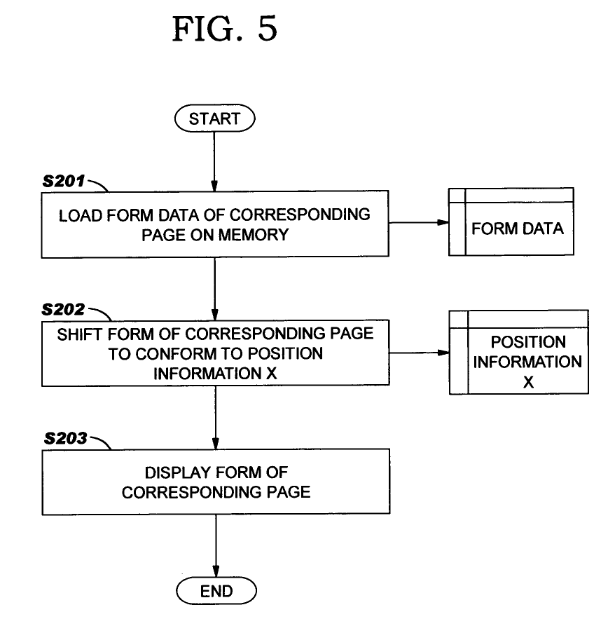

Now, the above-mentioned form shifting function SA will be described in detail. FIG. 5 is a flowchart showing the flow of a process of the form shifting function SA. The form shifting function provides the capability to jump from an old page to a new page, and have new page display the same display area as was displayed on the old page. With this function, the same area as that of the previously displayed page can be displayed even if a page switches to another page. This ensures that the same item or the same entry is displayed in the next page.

In this process, form data on a page to be displayed next (generally called “the next page,” hereinafter referred to as a “corresponding page”) is loaded on memory (step 201). Then, position information X stored in storage unit 30 is read out, and a form of a corresponding page is shifted to conform to the position information X (step 202). Specifically, the position of a corresponding page is operated on the basis of the position information X read out at position information operation unit 52, and then the corresponding page is shifted by form data shifting unit 53. Next, the shifted corresponding page is displayed on form page displaying unit 43 (step 203), and the process ends.

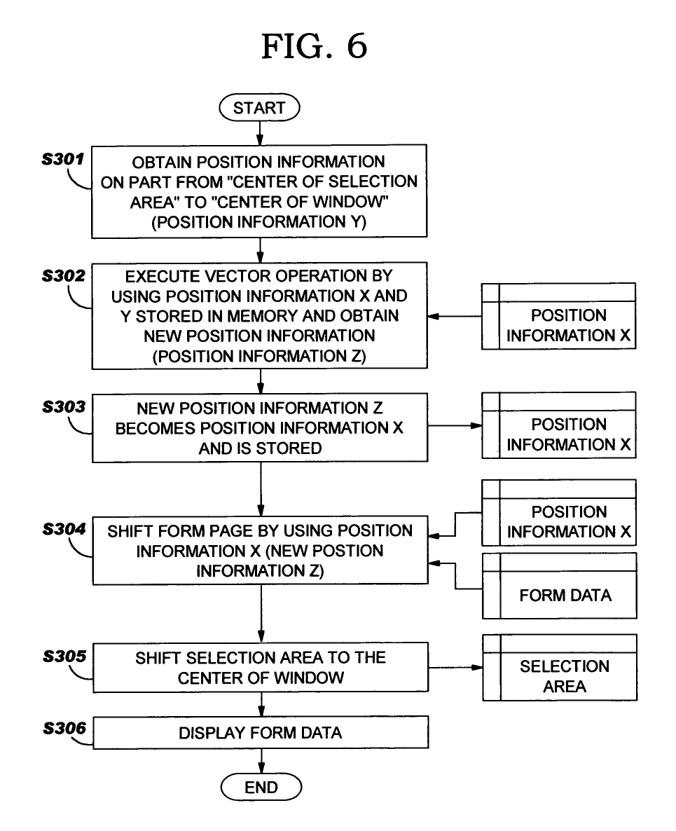

Now, the above-mentioned automatic scrolling function SB will be described in detail. FIG. 6 is a flowchart showing the flow of the automatic scrolling function SB. The automatic scrolling function automatically displays a selection area selected by an operator in the center of a window. With this function, an item that an operator wants to check can always be displayed in the central region of a window, which makes the operator's visual check easier.

In this process, position information obtaining part 51 first obtains position information on a part from the center of the selection area currently displayed in a window to the center of the window, and stores the information in storage device 30 as position information Y (step 301). Position information Y is also vector information which includes components of a distance and a direction, as is the above-mentioned position information X. Then, position information X stored in storage device 30 is read out, a vector operation is executed in position information operation unit 52 by using position information X and position information Y, and new position information Z is obtained (step 302). The new position information Z is also vector information which includes components of a distance and a direction. Then, the new position information Z becomes position information X, and is stored in storage unit 30 (step 303). Position information X (new position information Z) stored in storage device 30 and form data are read out, and a currently displayed form page is shifted to conform to position information X by form data shifting unit 53 (step 304). In tune with this shift, a selection area is shifted to the center of a window (step 305). The previous selection area is replaced with the shifted selection area for storing in storage unit 30. Then, the shifted form is displayed by form page displaying unit 43 (step 306), and the process ends.

Each of the above-mentioned techniques for the position information obtaining unit 51, the position information operation unit 52, and the data shifting unit 53 is illustrative rather than limiting; other techniques may be used as well.

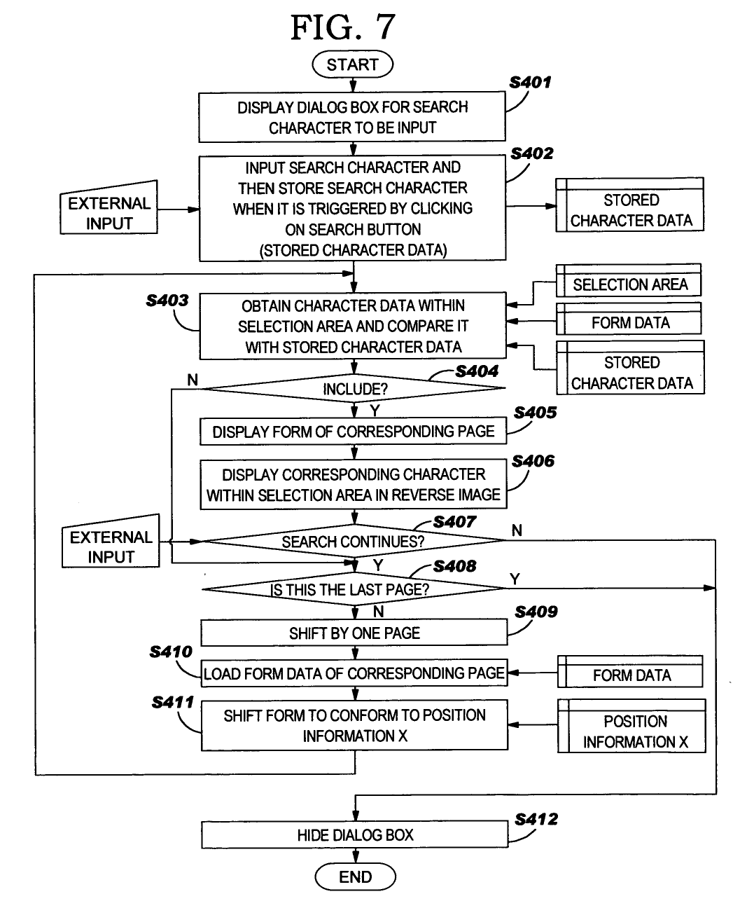

The above-mentioned searching function SC will now be described in detail. FIG. 7 is a flowchart showing the flow of the searching function SC. The searching function searches a selected area specified by the operator for a character string that the operator may specify. Particularly in this illustrative embodiment, a search can be made for a selected area specified by an operator over a plurality of pages (a plurality of form pages) making up form data. For example, an entry of interest to the operator can be searched in the case of a form.

In this process, window display unit 41 first displays a dialog box for accepting a search character (step 401). The operator enters a search character from external input unit 20, and then, by clicking on the search button, triggers storing of the search character into storage unit 30 as stored character data (step 402).

Then, searching unit 60 obtains character data within a selection area of a page (a form page) currently displayed from storage unit 30, reads out character data stored in storage unit 30, and then compares the two (step 403). A determination is made as to whether the character data within the selection area includes the stored character data or not (step 404). If the character data within the selection area includes the stored character data, a form of the corresponding page is displayed on form page displaying unit 43 (step 405), and the corresponding character within the selection area (a character corresponding to the stored character data) is in a reverse image (step 406). Next, a determination is made as to whether the search continues or not, on the basis of a command to external input unit 20 by an operator (step 407). If the search continues, a determination is made as to whether the page currently displayed is the last page or not (step 408). If the character data within the selection area does not include the stored character data at step 404, the process directly proceeds to step 408. If the search does not continue at step 407, the dialog box displayed at step 401 is hidden (step 412), and the process ends. If the page currently displayed is the last page at step 408, the process proceeds to the above-mentioned step 412, where the process ends. If the page currently displayed is not the last page at step 408, the process proceeds to the next page by shifting by one page (step 409), and form data of the corresponding page (the next page) stored in storage unit 30 is loaded (step 410). Then, position information X stored in storage unit 30 is read out, a form of the corresponding page is shifted to conform to position information X (step 411), and the process returns to step 403. As a result, the same area as on the previous page is displayed in the following page.

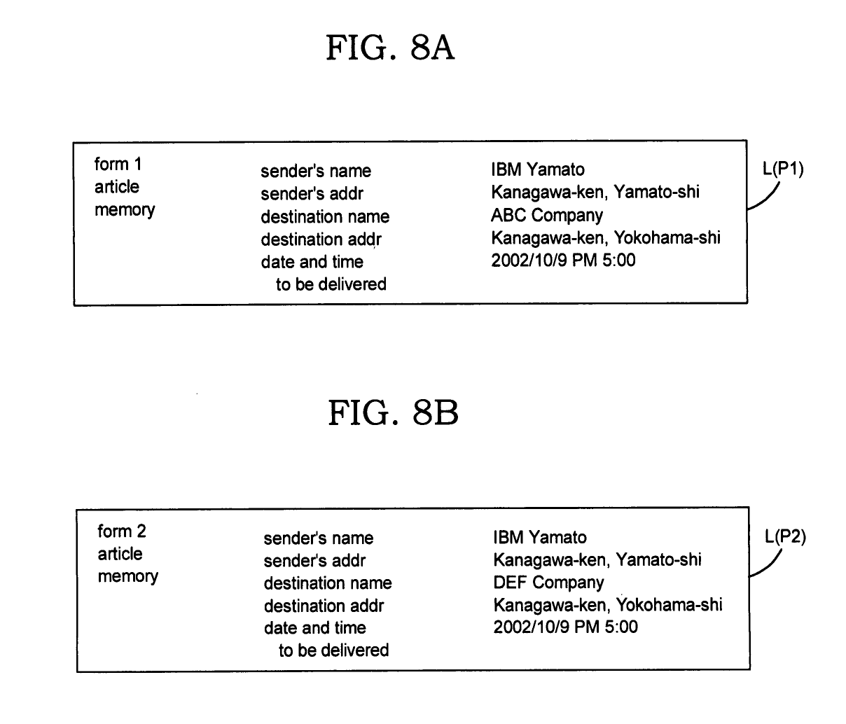

The above-mentioned form displaying process will now be described in conjunction with a specific example. FIGS. 8A and 8B show an example of form data L, with FIG. 8A showing first form page P1 and FIG. 8B showing second form page P2. Each of form pages P1 and P2 is proved with items of “ARTICLE,” “SENDER'S NAME,” “SENDER'S ADDRESS,” “DESTINATION NAME,” “DESTINATION ADDRESS,” and “DATE AND TIME TO BE DELIVERED, which are filled with respective pieces of information. Of course, the form may have more than two pages.

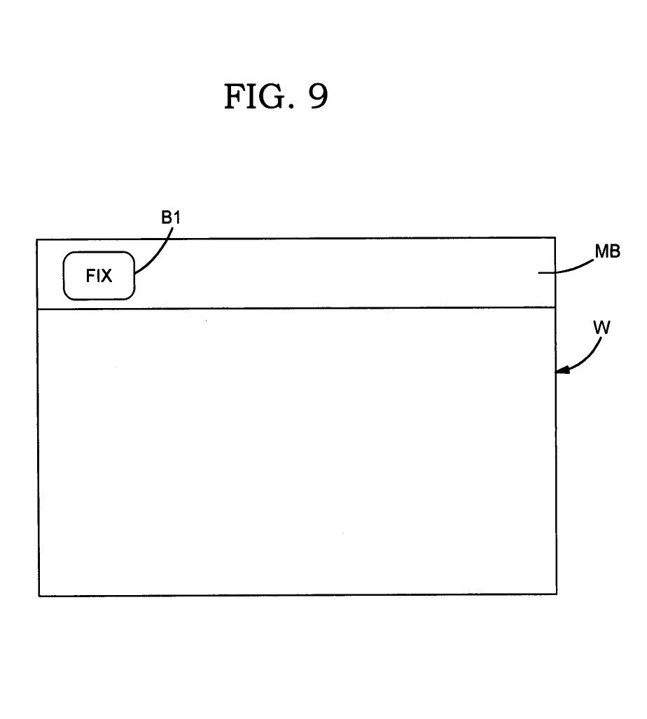

FIG. 9 shows window W and FIX button B1 displayed on display device 105 at step 101. FIX button B1 is displayed at the leftmost part of menu bar MB provided in the upper part of window W.

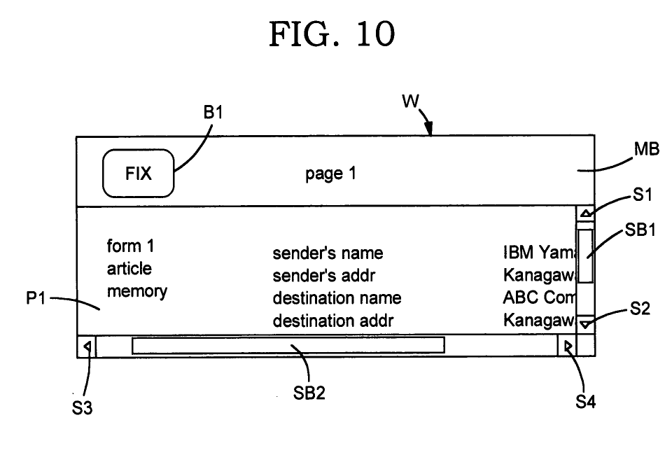

FIG. 10 shows form page P1, the first page displayed in window W at step 103. In this state, the upper left edge of a display area in window W and the upper left edge of form page P1 are displayed to match with. In the central region of menu bar MB, “PAGE 1” is displayed, indicating that it is a first page. In this example, as the size of window W is smaller than that of form page P1 so only a part of the form page P1 is displayed in window W along with a vertical scroll bar SB1, upward scroll button S1, and downward scroll button S2 at the right side of window W, and horizontal scroll bar SB2, leftward scroll button S3 and rightward scroll button S4 at the bottom of window W.

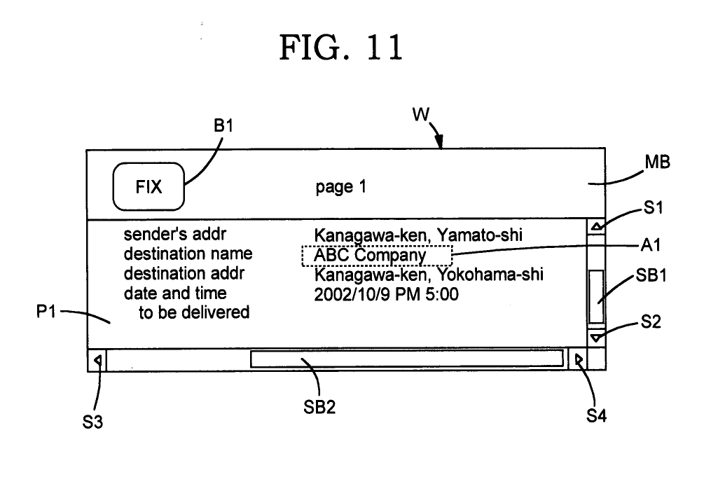

FIG. 11 shows form page P1 to be displayed in window W shifted as specified by the operator at step 104. In this example, it is assumed that the operator wants to check the entry of “DESTINATION NAME” (“ABC Corporation” in form page P1). As “DESTINATION NAME” is displayed to the right of the central region of form page P1 (see FIG. 8), the operator controls downward scroll button S2 and rightward scroll button S4 to display the corresponding part. FIG. 11 shows that an area containing “ABC Corporation” as “DESTINATION NAME” is selected as selection area A1 at step 105 as is shown in the figure by a broken line. This selection area A1 is displayed in a reverse image, for example, at step 106.

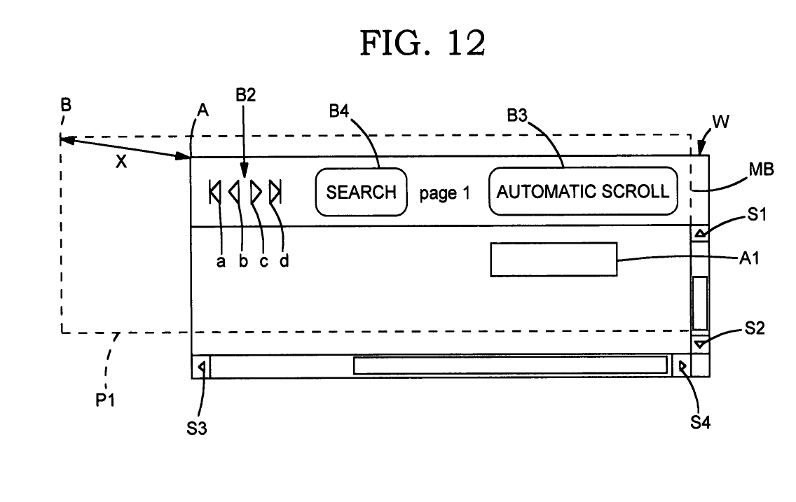

FIG. 12 shows the state after the FIX button is clicked at step 107. The distance and direction between the upper left point A in window W and the virtual upper left point B in form page P1 surrounded by a broken line in the figure become position information X to be stored at step 108. FIG. 12 also shows that window W further displays “FORM SHIFT” button B2, “AUTOMATIC SCROLL” button B3, and “SEARCH” button B4. FORM SHIFT button B2 includes the following four buttons (from left to right in the figure): “RETURN TO THE FIRST PAGE” button “a,” “RETURN TO PREVIOUS PAGE” button “b,” “PROCEED TO THE NEXT PAGE” button “c,” and “PROCEED TO THE LAST PAGE” button “d.”

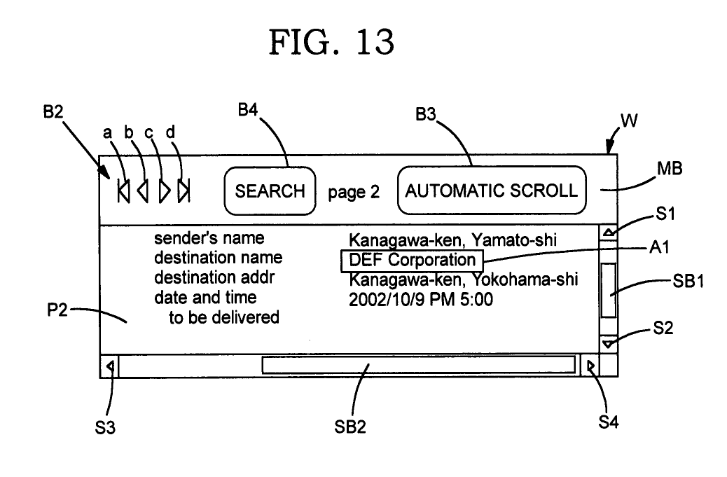

FIG. 13 shows the second form page P2, which is displayed in the window W when the “RETURN TO THE NEXT PAGE” button “c” of “FORM SHIFT” button B2 is clicked at step 110 and form shifting function SA is executed. Then, the same area in form page P2 as that in the previous form page P1 (see FIG. 11) appears in window W. Selection area A1 is also displayed in the same area, with the destination name of “DEF Corporation” highlighted. “PAGE 2” is also displayed in the central region of menu bar MB, indicating that it is a second page.

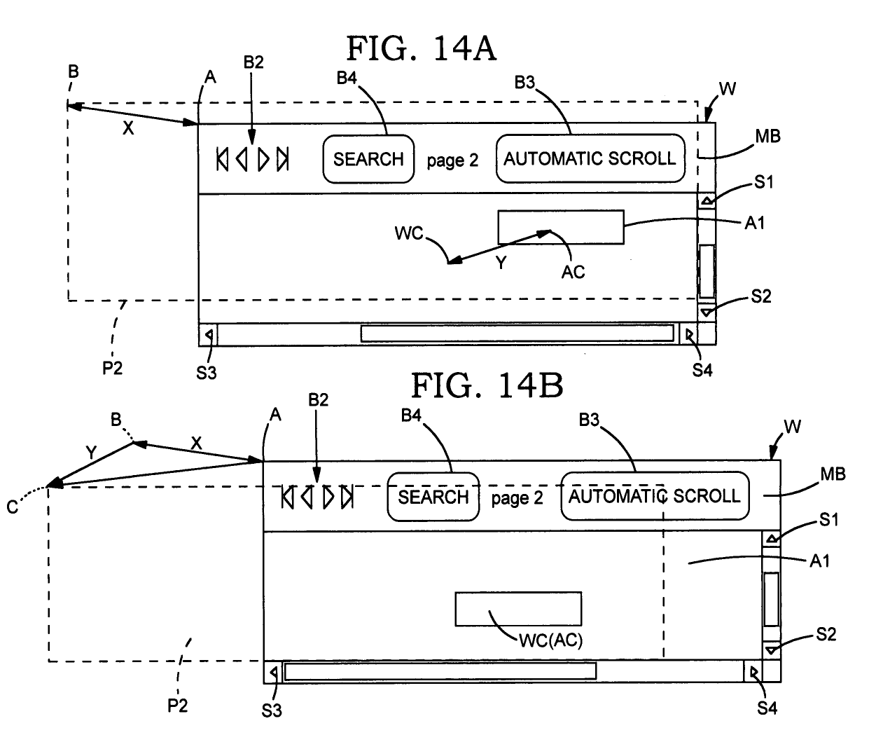

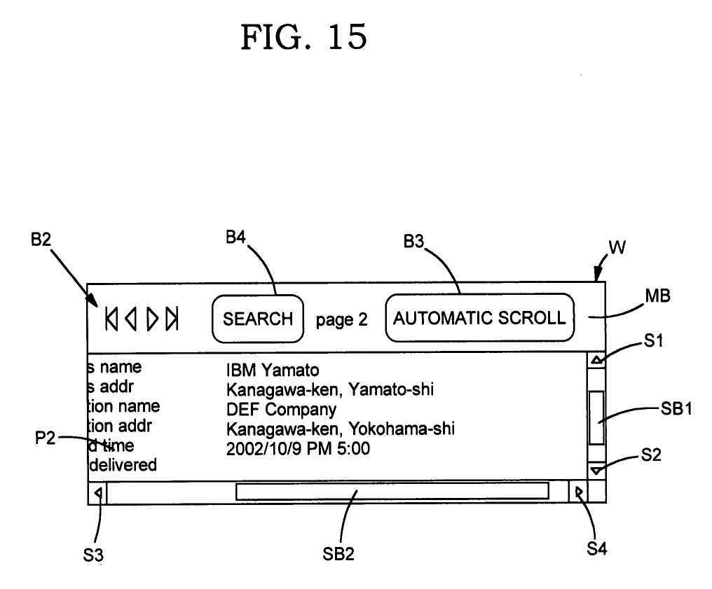

FIGS. 14A and 14B show a process of displaying selection area A1 in the center of window W when the “AUTOMATIC SCROLL” button B3 is clicked on at step 111 and automatic scrolling function SB is executed. FIG. 14A shows a state wherein position information Y is obtained at step 301. Information on a part between the center WC of window W and the center AC of selection area A1 is position information Y. FIG. 14B shows a state wherein form page P2 is shifted by using position information X (new position information Z) at step 304, and selection area A1 is shifted to the center of window W at step 305. In this state, position information X (new position Z) defines the upper left point C of form page P2, and the center WC of window W and the center AC of selection area A1 align. FIG. 15 shows a state wherein selection area A1 of form page P2 is displayed in the center of window W.

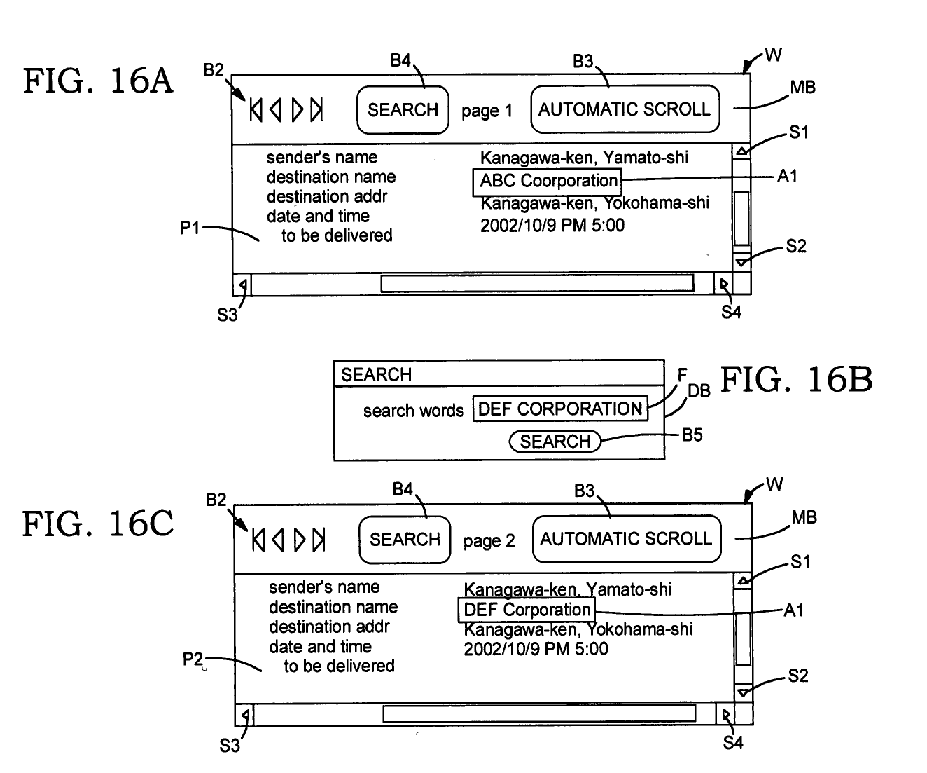

FIGS. 16A and 16B show a process of searching a character string within selection area A1 when “SEARCH” button B4 is clicked on at step 112 and searching function SC is executed. FIG. 16A shows a state wherein form page P1 is displayed in window W and “ABC Corporation” is specified for “DESTINATION NAME” as selection area A1. FIG. 16B shows a dialog box DB that contains field F for search characters (here, “DEF Corporation”) to be input at step 401. At the bottom of this dialog box DB, “SEARCH” button B5, which when clicked triggers an action at step 402. FIG. 16C shows a state wherein, after “DEF Corporation” in form page P2 is found through steps 403 and 404, the corresponding character “DEF Corporation” in selection area A1 is displayed in a reverse image at step 405.

As mentioned above, according to this exemplary embodiment of the invention, a display area of form page P1 corresponding to that of form page P2 is displayed when a transition occurs from a state of displaying form page P1 to a state of displaying form page P2. That facilitates the operator's check of an entry as if the operator were actually turning pages of a bundle of slips.

Thus, a selected area specified by an operator can always be displayed in the center of window W, thus making it easier for the operator to check entries. Further, an operator can search a character within selection area A1, which the operator specifies, over a plurality of pages.

Although a PDF file is used as form data L in the description of the invention so far as a convenience, this is not a limitation of the invention; rather, form data L can be properly selected from files in text forms or image forms, for example.

In the foregoing discussion, page shifting is triggered by clicking on the “FORM SHIFT” button B2 displayed in menu bar MB in window W. This is not a limitation of the invention. Page shifting may also be triggered by pressing a “PAGE UP” or “PAGE DOWN” key of keyboard/mouse 111 without displaying “FORM DISPLAYING” button B2 as shown.

Although obtaining of position information X is triggered by clicking on the FIX button B1 in the illustrative embodiment, this is not a limitation of the invention; position information X can be obtained as well without providing the FIX button B1.

Although the invention is illustrated here using an exemplary case wherein a file contains a plurality of form pages, each of which corresponds to one page, this is not a limitation of the invention. Rather, the invention applies as well to a case wherein one form file corresponds to one page as well as one file, and a plurality of files made up in this manner are displayed one after another. The invention can be applied to other kinds of pages as well as forms, for example applied to the front page of a published patent.

What is claimed is:

1. A file display device, comprising:
display means for displaying a content of a file having a plurality of pages in a window;
storage means for storing a display area of a given page of the file displayed in the window; and
determination means for determining a display area of a page to be displayed next in the window, based on the display area of the given page stored in the storage means.

2. The file display device according to claim 1, wherein the determination means determines a display area of a page to be displayed next so that the same display area as that of the given page is displayed.

3. The file display device according to claim 1, further comprising directing means for outputting a direction to the storage means, wherein the storage means stores a display area of a given page displayed in the window when the storage means receives a direction from the directing means.

4. The file display device according to claim 1, further comprising area selection means for selecting a certain area within the given page displayed in the window.

5. The file display device according to claim 4, wherein the certain area selected by the area selection means is also displayed in a page other than the given page.

6. The file display device according to claim 4, further comprising sifting means for shifting the certain area selected by the area selection means so that the certain area is substantially at the central region of the window.

7. The file display device according to claim 4, further comprising searching means for searching text information within the certain area selected by the area selection means over a plurality of pages in the file.

8. A form display device, comprising:
a storage unit for storing a form file, wherein a single form page generated conforming to a given regular form corresponds to a single page and a plurality of form pages composes a single file;
a display unit for displaying the form file stored in the storage unit in units of a page; and
a display determination unit for determining a display area of the form file on the display unit so that the display area is fixed to the same position within the form when the page is switched to another page.

9. The file display device according to claim 8, further comprising a direction unit for directing the display determination unit to place an area within the form in the central region of the display area.

10. The file display device according to claim 8, further comprising:
a selection unit for specifying a given area within the form as a selection area; and
a searching unit for searching text information within the selection area specified by the selection unit over a plurality of form pages in the form file.

11. A file display method of displaying a file having a plurality of pages in a window of a display, comprising the steps of:
displaying a given page in the file in the window;
storing a display area of the given page displayed in the window; and
displaying another page in the file in the window so that the same display area as that of the given page is displayed on the basis of the display area of the stored given page.

12. The file display method according to claim 11, further comprising the steps of:
selecting a certain area within the given page displayed in the window; and
displaying the certain area in the window with the area shifted into substantially the central region of a display area of the window.

13. The file display method according to claim 11, further comprising the steps of:
selecting a certain area within the given page displayed in the window;
receiving a keyword associated with selected the certain area;
comparing the keyword with text information contained in the certain area corresponding to each page of the file one after another; and
displaying a page of the file containing the text information in the window if the keyword and the text information match.

14. A display method, comprising the steps of:
displaying a first page in a window on a display;
storing a display area of the first page displayed in the window; and
displaying a second page in the window so that the same display area as that of the first page is displayed, based on the display area of the stored first page.

15. A program product for causing a computer to execute a function of displaying a file having
a plurality of pages in a window on a display, the program causing the computer to execute the functions of:
displaying a given page in the file in the window;
storing a display area of the given page displayed in the window; and
displaying another page in the file in the window so that the same display area as that of the given page is displayed, based on the display area of the stored given page.

16. The program product according to claim 15, wherein the program further causes the computer to execute the functions of:
selecting a certain area within the given page displayed in the window; and
displaying the certain area in the window with the area shifted into substantially the central region of the display area of the window.

17. The program product according to claim 15, wherein the program further causes the computer to execute the functions of:
selecting a certain area within the displayed in the window;
receiving a keyword associated with the selected the certain area;
comparing the keyword with text information contained in the certain area corresponding to each page of the file one after another; and
displaying a page of the file containing the text information in the window if the keyword and the text information match.

18. A program product causing a computer to execute the functions of:
displaying a first page in a window on a display;
storing a display area of the first page displayed in the window; and
displaying a second page in the window so that the same display area as that of the first page is displayed, based on the display area of the stored first page.
